(19) United States
(12) Patent Application Publication
(10) Pub. No.: US 2024/0077394 A1
(43) Pub. Date: Mar. 7, 2024

(54) APPARATUS, PLANT AND METHOD FOR INSPECTING FLEXIBLE PACKAGES

(71) Applicant: DACHI S.R.L., Alba(CN) (IT)

(72) Inventor: Ferruccio MARINO, Alba (Cuneo) (IT)

(21) Appl. No.: 18/270,029

(22) PCT Filed: Dec. 31, 2021
(86) PCT No.: PCT/IB2021/062520

§ 371 Date: Jun. 28, 2023

(30) Foreign Application Priority Data
Dec. 31, 2020 (IT) 102020000032969

(51) Int. Cl. G01N 3/12

(52) U.S. Cl. CPC G01N 3/12

(57) ABSTRACT

Apparatus for inspecting flexible packages is provided. The apparatus includes an inspection chamber having a closeable opening for the passage of a sample to be examined and associatable with means capable of generating a decrease in the pressure inside the inspection chamber, a programmable electronic processing unit, a measuring unit controlled by the programmable unit for measuring at least one geometric parameter of a sample received in the inspection chamber, and a pressure sensor unit comprising at least one pressure sensor associated with the programmable unit and capable of measuring the pressure inside the inspection chamber. The electronic unit is programmed to determine a variation, if any, of at least one geometric parameter of the sample as a result of pressure variations with the inspection chamber.

### TECHNICAL FIELD

The present invention relates to an apparatus, a plant and a method for inspecting flexible packages.

The invention finds application especially, though not exclusively, in the food and pharmaceutical industry.

### BACKGROUND ART

In many fields, and particularly in the food and pharmaceutical field, marketed products are enclosed within packages made with flexible films, typically made of plastic materials of different kinds. The packaging quality, both from the structural and the aesthetical viewpoints, and most of all the hermetic sealing of the flexible packages enclosing the marketed products, are key factors for proper preservation and display of the product contained therein.

In many industrial applications, it is therefore necessary to check whether the process standards required by the kind of product received in the package as well as by the regulations currently in force are met and kept over time.

According to prior art, the inspection of flexible packages can take place continuously during normal operation of a production plant, for example a plant for packaging foodstuffs or pharmaceutical products, by picking, typically with a predetermined frequency, samples of a packaged product and subjecting them to one or more inspection tests in a station separate from the production line.

Specific inspection tests are further necessary for example in the case where the production plant has undergone changes, such as a simple replacement of exhausted reels of packaging material, a change in the production rate, maintenance work or any operations that may have altered the packaging result.

Furthermore, it may be necessary to effect special inspections of the hermetic sealing of the package, in the case where, for example, the product has to be transported by air, where it can be subjected to pressures lower than atmospheric pressure, which pressures can cause breakage of the package.

At present, inspections of the hermetic sealing of flexible packages are carried out with involvement of human staff and by applying several methodologies.

A first known inspection mode for flexible packages provides for a non-destructive test in which a package sample to be tested is placed in a hermetic sealed chamber. The chamber is put under vacuum by means of a vacuum pump until a predetermined vacuum value is reached.

If the package explodes, or cracks, before said predetermined threshold is reached, this means that it has failed the test. This mode has the drawback that it is not suitable for detecting leaks in a continuous industrial process. Moreover, this mode does not provide sufficient guarantee of the quality of the package if the package passes the test, and it does not provide indications useful for identifying the cause of the problem that has caused the defect in the packaging process.

A second known inspection mode provides for a destructive test, in which the sample is placed onto the bottom of a tank containing water and housed in vacuum chamber. The chamber is brought to pressures lower than atmospheric pressure by means of a vacuum pump and, in the case that the sample presents leaks, the operator may visually appreciate the presence of small air bubbles coming out of the package. According to this mode, it is the operator who must discriminate between acceptable and unacceptable leaks, but they are unable to understand whether leakage is caused by a defect present on the welded points of the package or it is caused by the intrinsic permeability, not meeting the requirements, of the material of which the package is made. According to this mode, even if the sample passes the test, it can no longer be used, because during the test the package is soaked and the product may come into contact with contaminants.

A third known inspection mode involves use of a chamber put under vacuum and immersed in a contrast liquid. This type of test is clearly destructive and requires placing the sample onto the bottom of a tank containing an aqueous solution of a contrast liquid, usually methylene blue. The chamber is placed under pressures lower than atmospheric pressure, thus causing expansion of the package. When the chamber is ventilated to restore the atmospheric pressure, if hermetic sealing defects are present in the package, the solution penetrates into the package and comes into contact with the product contained therein. At the end of the test, the operator visually inspects the product and if the product has turned colored in blue, this means that the package has failed the test. It has to be noted that even if the test has been passed successfully, the sample can no longer be used, because of the high coloring power of methylene blue, which damages the package. Furthermore, this known technique is not suitable for identifying micro-leaks.

A fourth known inspection mode involves a non-destructive test using a chemical inspection with gas detection. This type of test can be applied only to packages in which gases other than air, usually CO₂ or N₂, have been preliminary introduced, for reasons of product preservation. The packaging method using gases other than air is also called MAP (Modified Atmosphere Packaging), and the quality inspection for packages made by means of this method provides for placing the package sample into a tight chamber, which is then put under vacuum over a predetermined time interval. A sensor of a gas detector capable of monitoring the concentration of the tracking gas within the inspection volume is placed inside this chamber. If the package presents leaks, the gas exits the package and the sensor detects a change in the concentration thereof within the chamber. The MAP technique is usually more expensive than conventional packaging methods and is therefore employed solely in those cases where it is necessary for reasons of product preservation. In the case where the used gases, for example CO₂ or N₂, are already present in remarkable quantities in the air, very accurate and expensive sensors must be used in order to maintain reliable measurement. These sensors have the drawback that they require frequent maintenance and calibration, with consequent burden on instrument management costs. When using rarer gases, for example H₂ or He, less accurate sensors can be used, but the packaging cost is remarkably increased because of the higher cost of such gases. In addition, with this technique it is impossible to identify the reason of the leakage, let alone locate it.

A fifth known mode consists in an inspection with pressure difference. This is a non-destructive test, in which the sample is placed into a tight chamber in which vacuum is created. If the sample presents leaks, a raise in the pressure inside the inspection volume is detected, due to the volume of gas liberated from the package. In order to obtain reliable measurements, it is necessary for the chamber to have a volume not too much larger than the maximum volume reached by the sample during the vacuum peak. Furthermore, the measurements can be flawed by inevitable air infiltrations into the chamber of the instrument. In addition, this technique does not allow to recognize the origin of the leakage nor the position thereof.

JP2009029464A describes a system for inspecting hermetic sealing of flexible packages, in which hermetic sealing inspection is carried out directly on the packaging line. The speed of the line will therefore have to take into account the time required for carrying out the test and in case be reduced if it is too high. The package under test is subjected to a vacuum along the packaging line and the geometric deformation undergone by the package is measured by means of an ultrasound or infrared sensor.

EP1333267A1 describes a system for inspecting hermetic sealing of blisters, which provides for the operator to place a blister to be tested into a laboratory machine. This machine, inside a darkroom, applies a vacuum to the inspection volume and measures the change in the volume of the product by means of a laser emitter and detector.

U.S. Pat. No. 5,287,729A describes an inspection system in which a package is introduced into a chamber the walls of which adhere to the wrapper. Continuous modulation of pressure is applied to the chamber, and the response of the sample is measured by means of load cells capable of signaling a value of force applied to the walls of the measurement chamber by the wrapper.

The technologies currently in use for inspecting the quality of flexible packages employ one of the above-described modes, or a combination thereof, but some of them have limitations in that human intervention is required in one or more steps of the inspection process, in particular in the most critical step of judging the quality of the package.

Attempts have also been made for a massive in-line inspection, but the results have proven unsatisfactory due to the fact that in this case only non-destructive inspection can be employed and also because of the limitation caused by the time required for carrying out the test, which can jeopardize the productivity of the line.

The technologies using optical sensors usually have also the drawback of being unsuitable for packages made of a transparent or reflective material. Ultrasound sensors, instead, have the drawback of being influenced by disturbances from other machinery present in the packaging line or in the production plant. Lastly, load cells do not allow to reach high sensitivities when elastic wrappers are present.

As is known, absolute hermetic sealing of the package cannot be reached, both because of welding defects that may occur during packaging and because of the gas permeability of the materials used for producing the package. For this reason, it is crucial to discriminate between a negligible leakage, which therefore has little opportunity to jeopardize preservation of the product, from a major leakage, caused by gross defects present in the package.

Known apparatuses and methods for inspecting flexible packages are also configured to operate over a single type of packages or at most over some homogeneous types. In the field of packaging, however, several variants of packages, even very different from one another, are known. Suffice it to mention here, for example, the packages of the “pillow bag” type, square bottom bag type, “stand-up pouch” type, “flow pack” type, tube bag type, tuft bag type, “lid foil” type, “mono-pack” type, “stick pack” type, “flat bag” type, etc. . . .

A main object of the invention is to overcome the drawbacks of prior art, by providing an apparatus, a plant and a method for inspecting flexible packages, capable of signaling faults in the package, without the need for human judgement and with automated or semi-automated mode.

Another object of the invention is to provide an apparatus, a plant and a method of the aforementioned type that can be integrated in a production line, substantially without intervening onto the existing structures and therefore lend themselves to being implemented in a wide range of different situations and at convenient costs.

A further object of the invention is to provide an apparatus, a plant and a method for detecting faults or defects, for example due to leakages, in samples of flexible packages, that can be adapted to a plurality of packages of different type and therefore lend themselves to being employed in a wide range of different applications and practically in all fields in which flexible packages are employed.

Not least object of the invention is to provide an apparatus, a plant and a method that can be implemented industrially at low cost, for detecting faults or defects, for example due to leakages, in samples of flexible packages.

These and other objects are achieved with the apparatus, plant and method for inspecting flexible packages, as claimed in the appended claims.

### SUMMARY OF INVENTION

The apparatus according to the invention preferably provides for inspection to take place by means of monitoring the variation of at least one geometric parameter associated with the package, depending on the conditions applied to the package from outside, such as, for example, the pressure of the air surrounding the package.

According to a preferred embodiment of the invention, the apparatus for inspecting flexible packages essentially comprises an inspection chamber in which at least one package of the product to be tested can be received.

Preferably, the package to be tested is placed into the inspection chamber, into a seat, configured so as to prevent undesired shifting of the package during testing and limit deformation of the package in the directions not involved in the measurement.

Still according to the invention, the inspection chamber is adapted to be put under a pressure at least slightly lower than that present inside the package, which typically corresponds to the atmospheric pressure at the time of packaging the product. An excessive vacuum inside the chamber might indeed cause deformations and defects in the material of the package. In practice, therefore, the inspection chamber will be capable of being put under vacuum by means of suitable means such as, for example, a vacuum pump, or a vacuum line, when available at the site where the apparatus is used.

The inspection volume defined within the inspection chamber is associated with at least one measuring unit, preferably of the optical and/or mechanical type, capable of detecting at least one significant parameter, related to the geometry of the package sample present in the inspection chamber, and the variation of said parameter during testing.

The measuring unit preferably comprises an appendix, for example in the form of a small plate, having the function of a probe. Preferably, the appendix has a surface having a geometric shape complementary to that of the seat for the package to be tested, and an extension substantially comparable to that of said seat. The mass and shape of the appendix are preferably chosen according to the shape and rigidity of the package to be tested, so that a predetermined force, capable of preventing discontinuous deformation that could cause poorly fluid measurements, is applied onto the package.

The appendix functioning as a probe and the package seat can take specific shapes in order to adapt to the type of package to be tested. For example, the surface of said appendix intended to come into contact with the package can be flat, prism-shaped or “V”-shaped.

Measurement of the geometric parameters is preferably carried out indirectly by means of a sensor arranged outside the inspection chamber and capable of detecting variation in the position of the appendix. In a preferred embodiment of the invention, measurement takes place by means of a sensor measuring displacement of an element, for example made as a disc, attached to the appendix. This provision allows to prevent measurement from being disturbed by optical instruments pointed directly at the wrapper, and to provide a door having a transparent window allowing inspection of the chamber from outside.

Preferably, there is provided an optical sensor adapted to detect displacement of the appendix, for example made as a probe in the form of a small plate, and to generate a signal indicative of at least one geometric parameter of the package sample.

The measuring unit is connected to a programmable processing electronic unit, for example a PLC (Programmable Logic Controller), and is adapted to generate a signal indicative of variation in said parameter. The signal can advantageously be processed by the electronic unit in order to provide, for example though a user interface displayed on a display connected to the apparatus, the information concerning the result of the inspection carried out on the sample of package of the product. The electronic unit can further be advantageously connected, through a suitable interconnection interface, to a production line, in order to perform a data exchange. The data exchange between the apparatus according to the invention and the production line may be capable of coordinating operation of the inspection apparatus, according to the operational parameters of the line, for example the frequency of tests depending on the speed of the line, as well as of coordinating operation of the line depending to the results of the tests, for example by altering parameters of the line, such as production speed, or speed of welding of the film forming the package, depending on the quality of the product tested in the apparatus.

The invention further provides for measuring the relative pressure inside the inspection chamber. Said measurement is preferably performed by means of a pressure sensor, or pressure switch, connected to the electronic unit, which pressure sensor generates a signal indicative of the pressure value.

According to a preferred embodiment of the invention, the electronic unit is programmed to perform a measuring cycle or, more preferably, some measuring cycles, in which the sample of package to be tested is subjected to a vacuum over a certain time interval and it is subsequently brought again to the starting conditions. According to the invention, if, after the aforesaid cycle or series of cycles, the sample has regained its initial geometric conditions, or conditions close to the initial ones within a predetermined tolerance threshold, defects that may have been found can be considered negligible and the sample has passed the inspection test successfully. As perfect hermetic sealing of the package sample is impossible, micro-defects, due, for example, to micro-leaks, and consequent faults in the package will be observed in most of the cases of tested samples. The apparatus may therefore be calibrated and programmed according to the needs, to discriminate negligible defects and leaks from those of major importance and therefore capable of jeopardizing good preservation of the product contained in the package.

Preferably, according to the invention, the programmable unit can both control start and stop of the vacuum pump, or opening and closing of the valve intercepting the vacuum line, if any, in order to reach the programmed pressure value within the inspection chamber of the apparatus, and determine whether the measured parameters meet or not the predefined standards, for example imposed by the company manufacturing the food product enclosed within the package. In addition, all the adjustment and safety devices such as solenoid valves and micro-switches for optimal management of the apparatus are preferably connected to the programmable unit.

In a preferred embodiment of the invention, the appendix is brought into contact with the wall of the product package to be tested and preferably it is subsequently pressed, preferably however without deforming the product contained therein. This step can have the effect of stretching the wall of the product package to be tested and has the advantage of causing preferably smoothening of any folds and wrinkles that may be present in the package and bringing the package to an over-pressure condition, i.e. a condition in which the inner pressure is higher than the pressure present before the appendix is applied against the outer surface of the package. In this way, the pressure difference between the inside of the package and the volume of the inspection chamber is increased, and in order to perform the test it will therefore be sufficient to create a light vacuum in the inspection chamber.

This aspect is advantageous in that an excessive pressure difference might cause deformations and defects in the material of the package, thus distorting the results of the test.

It has to be noted that the appendix, for example made in the form of a small plate, pressed against the product package to be tested is capable of detecting at least one significant parameter related to the geometry of the package sample present in the inspection chamber, and variation in said parameter during testing, i.e. especially in the step in which the chamber accommodating the sample is put under vacuum. In order to reveal possible leaks, measurement of the spatial displacement of the appendix is more significant than a geometric measurement of the overall variation in volume of the package, detected for example with optical means such as a video camera, pointed directly at the product package. The variation in the volume of the product package, in the absence of deformations caused by outer mechanical members, such as, precisely, the appendix of the measuring unit according to the invention, is indeed often of little significance, with the same pressure difference between inside and outside of the package, due to the fact that the package deforms in a substantially unpredictable manner. The presence of a package portion pressed from the outside by means of the appendix and the measurement of the displacement of the appendix, to determine the variation in the volume of the product package, allow, instead, to appreciate even minimum variations, with a reduced pressure difference between inside and outside of the package.

In addition, an advantage of this preferred embodiment of the invention lies in that, owing to the pressure exerted by the appendix, the product package to be tested is capable of deforming in a more uniform and immediate manner according to the Pascal law. The presence of wrinkles and folds in the material of which the package is made, may indeed cause, at the time they are smoothened by emptying air from the inspection chamber, impulsive variations in the pressure inside the package, thus making the result of the test inaccurate.

In an embodiment of the invention, provided in particular for inspecting packages adhering to the outer surface of the products and thus substantially unable to deform when they are put under vacuum, the measuring unit capable of detecting at least one significant parameter related to the geometry of the package sample present in the inspection chamber, and the variation in the said parameter during testing, will advantageously be associated with an actuator capable of squashing and possibly breaking the product present inside the package, thus liberating the gas contained in the product. In this way, the gas contained in the product is liberated inside the package, which, when put under vacuum, will tend to deform, thus making possible to measure the variation in the geometric parameter of the package by means of the measuring unit.

In this case, the measuring unit may comprise an appendix, for example in the form of a small plate, having the function of a probe, and be connected to a pneumatic cylinder or equivalent thereto, capable of imparting an impulsive thrust onto the small plate, in order to cause the aforesaid effect of breakage of the product inside the package.

A typical example of package with the aforesaid features, adhering to the outer surface of the product, is represented by chocolate pralines, generally wrapped up, because of their nature, with a material adhering to the surface of the product (“flow pack”).

Advantageously, the apparatus according to the invention can perform several quality inspections over packages made of flexible materials. For example, the following inspections are possible:
inspection of the oxygen barrier and moisture barrier;
inspection of welding defects on the plastic film of which the package is made, for example defects causing leaks in regions welded with too high, or too low, melting temperatures;
inspection of the resistance of the film or welding;
inspection of the hermetic sealing properties upon variation of the welding parameters;
inspection of the defectiveness of the film in the wrapping process;
inspection of products adhering to the package;
inspection of proper positioning of product and package relative to printed characters or other signs provided on the package.

An operation cycle typical of the apparatus according to a preferred embodiment of the invention essentially comprises the following steps:

i) determining at least one geometric parameter of a package sample to be examined and accommodated within the inspection chamber when a starting pressure P₁ is established, wherein said pressure P₁ may also be different from the atmospheric pressure and, in particular, slightly lower than the atmospheric pressure;
ii) causing, inside the inspection chamber, a decrease in pressure until a predetermined pressure value P₂<P₁ is reached;
iii) causing, inside the inspection chamber, an increase in pressure until the starting pressure value P₁ is reached again;
iv) possibly repeating the steps ii) and iii) with the same or different pressure values;
v) determining the variation, if any, of said at least one geometric parameter of the sample, as a result of said pressure variations;
vi) generating a signal indicative of said variation, if any.

According to a particular embodiment of the invention, a product sample to be tested is subjected to a sequence of inspection cycles in which there is provided a step of comparing the curves indicative of variation of a geometric parameter of the package sample, upon variation of the pressure. The result of the comparison is advantageously indicative of the need to discard the tested product.

In particular, preferably, according to the invention said comparison takes place in conjunction with or as an alternative to one of the following:
the angular coefficient of the straight line (R) connecting the peaks of the curve indicative of the thickness, or height, variation of the package with a predetermined threshold;
the number of said peaks and the number of times in which a same straight line (R) intersects said peaks;
the angular coefficient of the straight line (R₁, R₂, R₃) whose equation corresponds to the linear regression of the points forming the plateaus of said curve with a predetermined threshold;
the distance dy of ordinates between the straight lines (R′) and (R″) passing through the last point of a plateau and the first point of the subsequent plateau with zero;
the distance dy of ordinates between the straight lines (R₁, R₂, R₃) passing through the first point of the plateau generated by the measurements under constant pressure at lower pressure threshold and the first point of the plateau generated by the measurements under constant pressure at higher pressure with zero;
the distance of ordinates between the last point or “knee” of the plateaus generated by the measurements under constant pressure with lower pressure and the straight line formerly defined, with zero;
the correlation between the curve indicative of the variation of a geometric parameter of the package sample and the curve indicative of the pressure variation inside the inspection chamber, with a predetermined correlation threshold.

According to a preferred embodiment of the invention, all the equipment, sensors and transducers, associated with the volume of the inspection chamber of the apparatus, is in communication with said chamber, whereby the pressure inside the equipment is equal to the pressure inside the inspection chamber, thus preventing pressure differences from altering the accuracy of measurement.

According to the invention, it may be provided that the package sample to be tested be picked from a production line and placed manually into the inspection chamber of the apparatus.

A first particular embodiment of a plant according to the invention provides that the package sample to be tested be picked by means of an automated pick-up mechanism from a transport line for packaged products and placed manually, or by means of a robot, into the chamber of the inspection apparatus.

A second particular embodiment of the plant according to the invention provides that the sample be picked by means of an automated pick-up mechanism from a transport line for packaged products and placed, still by means of the same mechanism, into the chamber of the inspection apparatus.

A first variant of this second particular embodiment of the invention provides that the inspection chamber be mounted slidably on a guide, preferably a vertical guide, in order to take a distal configuration and a proximal configuration with respect to to the pick-up mechanism and make the sample enter through an appropriate opening, preferably arranged below in the inspection chamber, when said sample is associated with the pick-up mechanism.

A second variant of this second particular embodiment of the invention provides that the pick-up mechanism be equipped with an oscillating plate for picking the sample to be tested, said plate being guided by an annular cam, in order to make the sample enter through an appropriate opening, preferably arranged below in the inspection chamber, when said sample is associated with the pick-up mechanism.

A further embodiment provides for combining the sliding movement of the inspection chamber with the oscillating movement of the plate with which the sample is associated.

According to a particular embodiment of the invention, picking of the product package to be tested takes place by means of pneumatic means such as, for example, gripping suckers. Said suckers are further intended to hold the product package also during the test in the inspection chamber and are therefore advantageously retractable into a support plate for supporting the product package to be inspected, in order to prevent the tested product sample from being in contact with deformable parts upon variation of the pressure inside the chamber. It is indeed evident that the product package to be tested has to be in contact with rigid, non-deformable surfaces when the inspection chamber is put under vacuum, and this in order to prevent alteration of the effect of the pressure variation on the package undergoing inspection.

Advantageously, the tests performed with the apparatus according to the invention are preferably non-destructive for the tested sample and it is therefore possible to perform frequent inspections over a large number of products, without additional costs caused by the destruction of samples and without jeopardizing the production capacity of the plant.

A further advantage of the invention derives from the fact that the kind of measures adopted allows accurate operations, with the same apparatus, on packages of different size, shape and rigidity.

Advantageously, the apparatus according to the invention allows to inspect packages made with any kinds of technologies, without the need to use a tracking gas.

Advantageously, according to the invention, the assessment of the entity of leaks that may be detected is performed autonomously by the apparatus, without resorting to subjective evaluations by an operator and is therefore substantially free from human errors.

Advantageously, the use of this automated apparatus allows the operator to save time and therefore increases the frequency of tests.

Advantageously, the integration of several physical and geometric parameters into a quality assessment algorithm allows detecting micro-defects due, for example, to micro-leaks, which may not be detected by other known systems for inspecting package quality.

Advantageously, the integration of several physical and geometric parameters allows clear and precise identification of the kind of defect and offers the possibility of determining what the problem underlying the poor packaging quality is and, accordingly, what countermeasure should be adopted.

Advantageously, the ease of construction of the apparatus and the limited number of components make the manufacturing of the apparatus quick and cost-convenient and malfunctions less frequent, and further facilitate periodic maintenance.

Advantageously, the apparatus is particularly compact, thus minimizing the space requirement in existing plants.

Advantageously, the apparatus can be cleaned easily and is not subject to the risk that the product contained in the package sample to be tested may come into contact with contaminants or colors, which may irreparably alter the package.

Advantageously, the method according to the invention provides for a quick run time, thanks to the measurements adopted, and therefore allows for more frequent inspections and the possibility of in-line integration of the apparatus, without significant slowdown of the production speed.

### BRIEF DESCRIPTION OF DRAWINGS

Some preferred embodiments of the invention will be provided by way of non-limiting examples with reference to the annexed drawings, in which:

FIG. 1 is a front perspective view of the apparatus with probe lowered and door open;

FIG. 2A is a view corresponding to FIG. 1 with probe lifted and product sample positioned in the inspection chamber;

FIG. 2B is a view corresponding to FIG. 1 with probe lowered and product sample positioned in the inspection chamber;

FIG. 3A is a rear perspective view from above of the apparatus of FIG. 1, partially open;

FIG. 3B is a partially broken side perspective view of the apparatus of FIG. 1;

FIG. 4A is a schematic view of the step of picking a sample to be tested from a transport line for packaged products according to a first embodiment of the plant according to the invention;

FIG. 4B is a schematic view of the step of transferring the sample to be tested in a first mode of the first embodiment of the plant according to the invention;

FIG. 4C is a schematic view of the step of transferring the sample to be tested from the cart to the apparatus in a second mode of the first embodiment of the plant according to the invention;

FIG. 5 is a schematic view of the step of picking and transferring a sample to be tested from the transport line for packaged products to the apparatus, in a second embodiment of the plant according to the invention;

FIG. 6 is a perspective view of the apparatus in a variant of the second embodiment of the plant according to the invention;

FIG. 7 is a perspective view of the apparatus in a particular embodiment of the variant shown in FIG. 5;

FIG. 8 is a schematic perspective view of a further embodiment of the invention;

FIG. 9A shows a diagram of a curve exemplifying the inspection method;

FIG. 9B shows a further diagram of a curve exemplifying the inspection method;

FIG. 9C shows a further diagram of a curve exemplifying the inspection method;

FIG. 9D shows a further diagram of a curve exemplifying the inspection method;

FIG. 9E shows a further diagram of a curve exemplifying the inspection method;

FIG. 9F shows a further diagram of a curve exemplifying the inspection method;

FIG. 9G shows a further diagram of a curve exemplifying the inspection method;

FIG. 9H shows a further diagram of a curve exemplifying the inspection method;

FIG. 9I shows a further diagram of a curve exemplifying the inspection method;

FIG. 10 is a diagram of a destructive inspection cycle;

FIG. 11 is a front plan view of a particular embodiment of the small plate.

### DESCRIPTION OF EMBODIMENTS

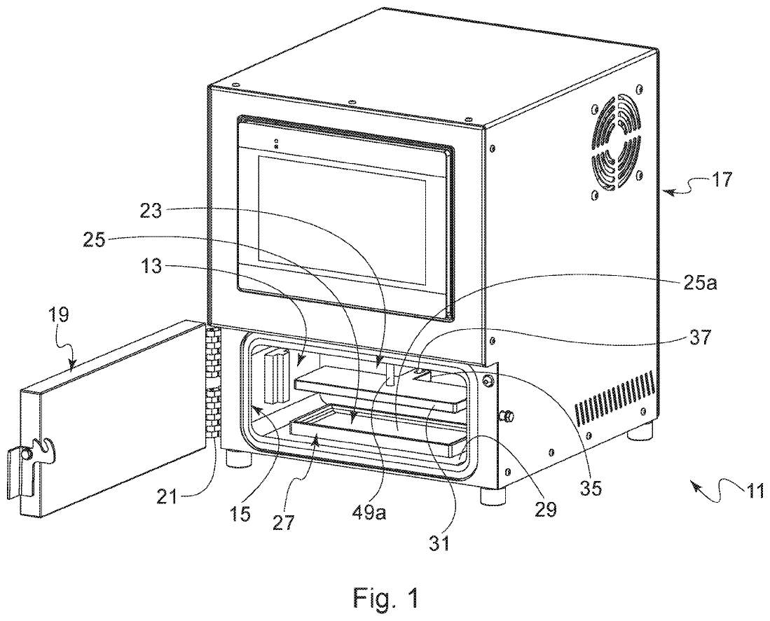

Referring to FIG. 1, an apparatus 11 according to a first preferred embodiment of the invention comprises an inspection chamber 13 provided with a closeable opening 15 for the passage of a package sample to be tested.

The inspection chamber 13 is defined inside a housing 17 and, in the shown embodiment, the opening 15 is formed on the front side of said opening 17 which as a whole has a substantially parallelepiped shape.

Still referring to the illustrated embodiment, the opening 15 has a substantially rectangular shape developing essentially horizontally and is closeable by means of a door 19 hinged laterally at 21 to the housing 17. The door 19 can be provided with a transparent window in order to allow inspecting the content of the chamber 13 even when the door 19 is closed.

In the figure, a measuring unit for measuring at least one geometric parameter of the package sample to be tested and comprising a mechanical linear transducer, or probe, 23 is partially visible through said opening 15.

In this embodiment, the opening 11 further comprises, inside the inspection chamber 13, a seat 25 for the package sample to be tested. Said seat 25 is preferably formed in a removable tray 27. In the illustrated embodiment, the removable tray 27 has a rectangular shape, but according to the invention it may advantageously be replaced with another flat tray, or a tray provided with a corresponding seat, for a product having a different shape and/or size. The tray 27 is housed in the inspection chamber 13 supported on the floor 29 of said inspection chamber.

Preferably, the seat 25 defined in the tray 27 is configured so as not to allow displacement of the package to be tested during the test and so as to limit deformations of the package in those directions that are not involved in the measurement of the volume variation.

The mechanical transducer 23 is provided with an appendix 31 in the form of a small plate extending in a plane substantially parallel to the floor 29 of the inspection chamber 13 and to the base 25a of the seat 25 intended to receive and support the package sample to be tested. Preferably, the small plate 31 has a surface with a geometric shape complementary to that of the seat 25, and an extension substantially comparable to that of said seat.

The sliding rod 49a of the mechanical transducer 23 is also visible in the figure. Said rod 49a is slidable along an axis substantially perpendicular to the floor of the inspection chamber 13 in order to generate, as will become more evident from the following description, a signal indicative of the proximal or distal configuration of the small plate 31, relative to the base 25a of the seat 25 formed in the removable tray 27.

In FIG. 1, the small plate 31 is illustrated partially lowered, i.e. in the configuration in which said small plate 31 is approaching the tray 27. Said small plate 31, in the illustrated embodiment, comprises a rear projection 35, coplanar relative to the plane of the small plate 31, to which a driving rod 37 is attached, controlled by a linear actuator, to move the small plate 31 in a vertical direction between said proximal and distal configurations with respect to the base of the tray 27.

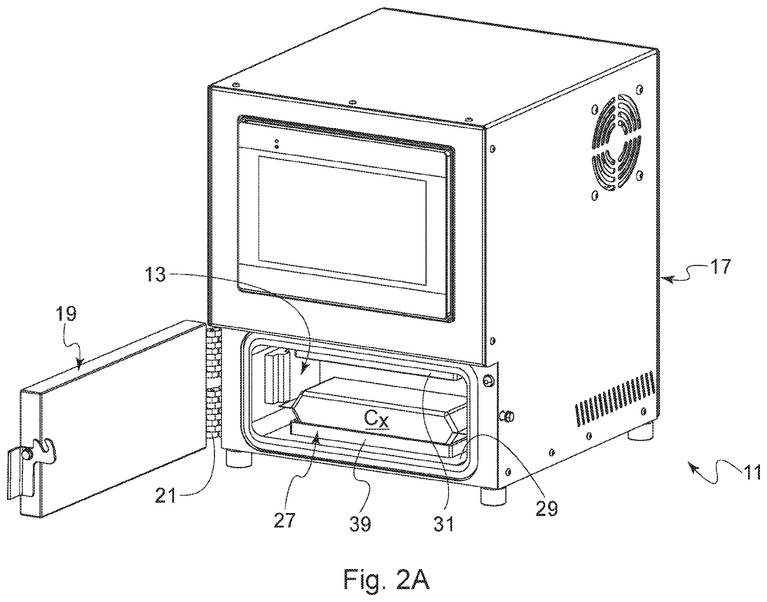

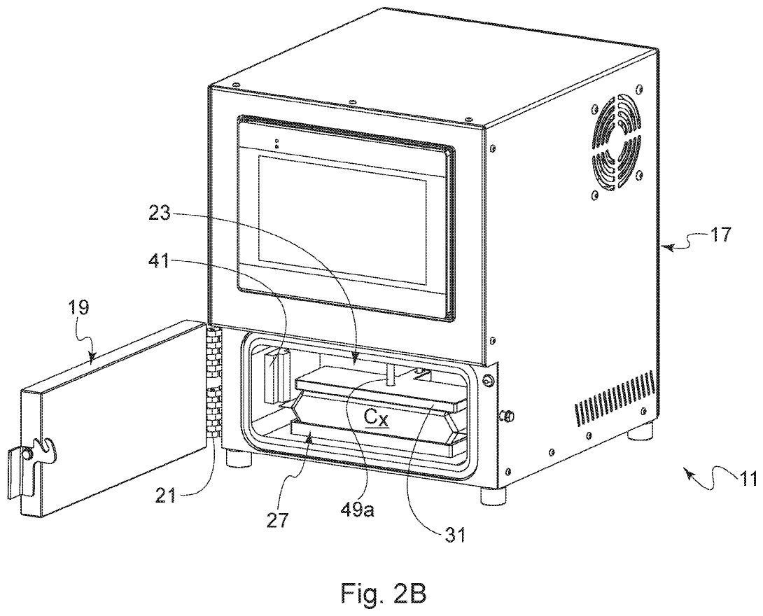

Referring to FIG. 2A, there is illustrated the apparatus 11 when a package sample C_{X} to be tested is received inside the inspection chamber 13 and the small plate 31 is in its lifted configuration, i.e. in its distal configuration with respect to the tray 27.

According to this embodiment of the invention, the sample C_{X} is advantageously held circumferentially in the seat 25 by the corresponding perimeter peripheral edge 39, surrounding said sample C_{X} when the latter is placed in a supported manner on the base of the tray 27.

Referring now to FIG. 2B, there is illustrated the apparatus 11 when a package sample C_{X} is received inside the inspection chamber 13 and the small plate 31 is in its lowered configuration, i.e. in its proximal configuration with respect to the tray 27 and therefore to the outer surface of the package sample C_{X} to be tested.

In the illustrated configuration, the small plate 31 can come into contact with the package sample C_{X} so that the linear position transducer 23 associated with the small plate 31 generates a signal indicative of the package geometric parameter associated with the thickness of the sample between the base of the tray 27 and the surface of the small plate 31 in contact with the material of the package sample C_{X}.

In this respect, it has to be noted, that, according to a preferred embodiment of the invention, the appendix formed by the small plate 31 is brought into contact with the wall of the product package to be tested and subsequently pressed in order to stretch the wall of the package sample C_{X}, preferably however without deforming the product contained therein. This step has the advantage of causing smoothening of the folds and wrinkles that may be present in the package and bring the package to a condition of over-pressure, i.e. a condition in which the inner pressure is higher than the pressure present before the small plate 31 is applied. In this way, the pressure difference between the inside of the package sample C_{X} and the volume of the inspection chamber 13 is increased and it will therefore be sufficient to create a light vacuum in the inspection chamber 13 in order to effect the hermetic sealing test on the sample C_{X}.

In the figure, an optical sensor 41 arranged on one of the inner side walls of the inspection chamber 13 is visible through the opening 15. The optical sensor 41 is capable of detecting a geometric parameter, for example the position of the upper edge of the outer wall of the package sample C_{X} received in the inspection chamber 13.

The optical sensor 41 is part of the measuring unit of the apparatus 11, which unit measures at least one geometric parameter of the package sample to be tested. Said measuring unit preferably comprises both the linear position transducer 23 and the optical sensor 41. In other embodiments, depending on the applications and the degree of measurement accuracy to be obtained with the apparatus 11, it will be possible to provide indifferently only one of the transducer 23 and the sensor 41, or it will be possible to provide more than one position transducer and/or more than one optical sensor. In particular, for inspecting samples of packages with transparent or semi-transparent wall, it will be preferable to provide the apparatus with at least the position transducer 23, the optical sensor 41 being sensitive to the degree of opacity and transparency of the material of the package.

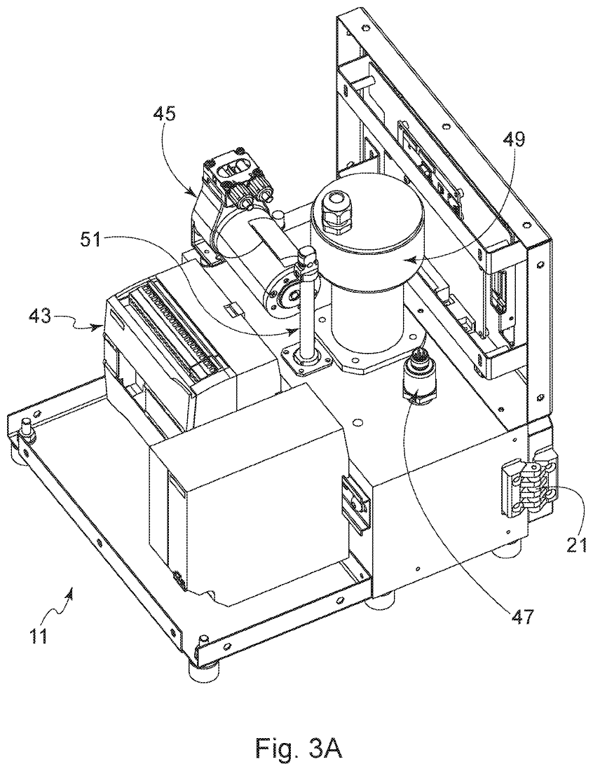

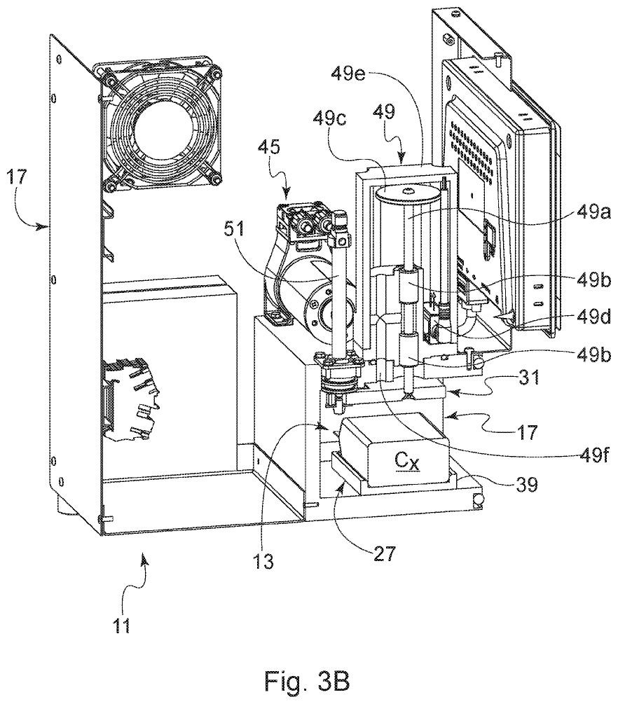

Referring now to FIGS. 3A and 3B, there is illustrated, in a rear view partially without housing and laterally in a broken view, respectively, the apparatus 11 of the preceding figures. As can be appreciated from the figures, inside the housing 17 there are housed essentially, in addition to the inspection chamber 13 previously described, a programmable electronic processing unit 43, a vacuum pumping unit comprising a vacuum pump 45, a pressure sensor unit intended for measuring the pressure inside said inspection chamber 13 and comprising a pressure switch 47, the measuring unit of the transducer 23, comprising for example a potentiometer 49 and a lifting cylinder 51, preferably of the type with pneumatic control, for lifting the small plate 31. In those environments in which a vacuum line is available, the apparatus 11 may have no vacuum pump 45, the latter being replaced with a check valve and a corresponding fitting for connection to said vacuum line.

According to this embodiment, the transducer 23 comprises a vertical rod 49a, slidable within a pair of bushings 49b. The rod 49a is associated below with the small plate 31 and carries above a disc 49c. An optical sensor 49d having an emitter directed towards the disc 49c is arranged inside the casing 49e of the encoder between the small plate and the lower base of said casing. Advantageously, according to the invention, during operation of the apparatus 11, the pressure in the volume within the casing 49e is equal to the pressure generated within the inspection chamber 13. In the illustrated configuration, this balance condition is obtained by means of a channel 49f which communicates the volume within the casing 49e with the volume within the inspection chamber 13. A same condition preferably occurs, according to the invention, for all the sensors and transducers with which the apparatus is equipped, so as to prevent pressure variation from causing deformations on the surfaces involved and consequent measurement errors.

The vacuum pump 45 is controlled by the programmable unit 43 and is also in communication with the inspection chamber 13, and is capable of varying the pressure, in particular of generating a vacuum, inside said chamber 13. A same result is achieved when the vacuum pump is replaced with a vacuum line available at the site where the apparatus 11 is installed.

A solenoid valve, not shown, is also controlled by the unit 43, preferably provided for communicating the outer environment with the volume within the inspection chamber 13 and therefore restoring the atmospheric pressure conditions inside the inspection chamber 13.

According to the embodiment of the invention, the electronic unit 43 in the illustrated embodiment is programmed to make the apparatus 11 perform the steps of:
i) determining, by means of said transducer 23 and said optical sensor 41 corresponding geometric parameters of the package sample C_{X} housed on the tray 27 when in the inspection chamber 13 there is present a starting pressure value P₁, for example equal to, or slightly lower than, the atmospheric pressure outside the inspection chamber 13;
ii) evacuating the inspection chamber 13 by causing a pressure reduction, i.e. a vacuum with respect to the outer environment, until a predetermined pressure value P₂<P₁, for example 0.8 bar, is reached by means of said vacuum pump 45;
iii) causing, inside the inspection chamber 13, a pressure increase until the starting pressure value P₁ is reached, for example by opening a solenoid valve which communicates said inspection chamber with the outer environment;
iv) possibly repeating the steps ii) and iii) with the same pressure values P₁, P₂ or other pressure values;
v) determining, by means of said measuring unit, any variations of said at least one geometric parameter of the sample, caused by said pressure variations;
vi) generating a signal indicative of said variations, if any, of said at least one geometric parameter.

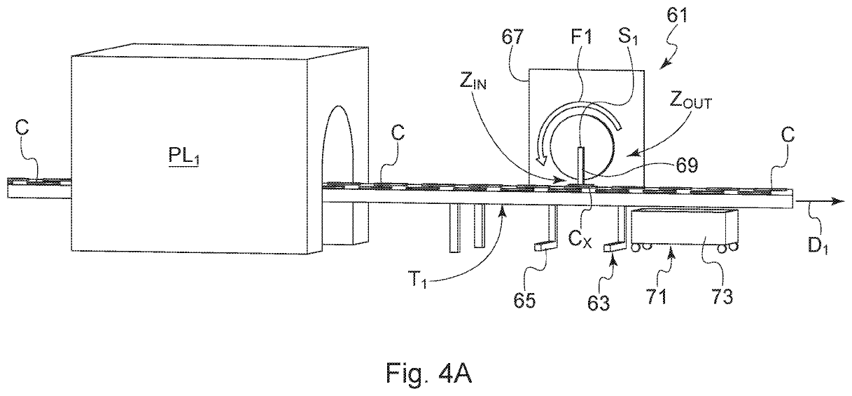

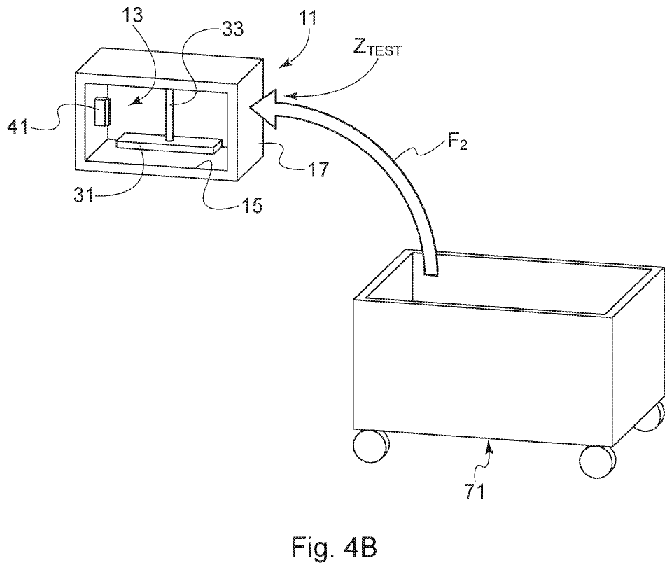

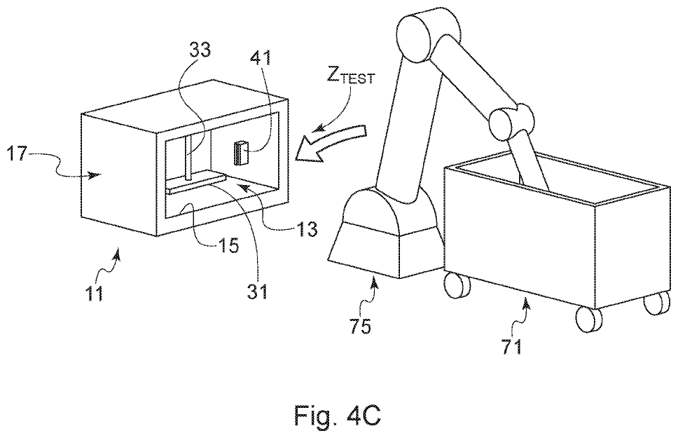

Referring to FIG. 4A, there is illustrated an embodiment of the apparatus 11 according to the invention, further comprising a pick-up mechanism 61 with reciprocating motion, capable of periodically picking a package sample C_{X} from a first position Z_{IN} on a transport line, so called “leg”, coming from a plant PL₁, schematically shown in the figure and comprising a conveyor belt T₁ on which a plurality of said packages C travel, and releasing said sample C_{X} in a second position Z_{OUT} distal to said transport line T₁.

In the illustrated embodiment, the pick-up mechanism 61 comprises an adjustable frame 63 provided with support feet 65 and a vertical portion 67 with which a crank handle 69 is associated rotatable about a rotation axis S₁ by means of motorized driving assembly, for example of the electric or pneumatic type, not shown.

The crank handle 69 is rotatably supported by a motor shaft coaxial to the axis S₁ and rotates in a plane substantially perpendicular to the plane of the conveyor belt T₁ and parallel to the advancement direction of the conveyor belt T₁.

For picking the sample C_{X} from the belt T₁, the crank handle 69 is provided with suitable gripping means, for example one or more contact suckers, or Bernoulli suckers, or mechanical gripping hands, as will become more evident with reference to the following description.

In this embodiment, the apparatus 11 further comprises a cart or automated shuttle 71, equipped with a collection tank 73, into which the samples C_{X} picked by the mechanism 61 are released by gravity.

In the illustrated embodiment, the crank handle 69 rotates in a counterclockwise direction concordant with the advancement direction D1 of the sample on the belt T₁ as shown by arrow F₁. In other embodiments, however, it will be possible to provide that the crank handle 69 rotate in the opposite clockwise direction.

According to this embodiment, or to any other embodiment providing for conferring the package sample to be tested into a stationary or moveable container, such as the shuttle 71, picking of the sample to be tested from the shuttle 71 may occur essentially with two modes.

A first mode is illustrated schematically in FIG. 4B and provides for manual picking, by an operator, of the sample C_{X} from the shuttle 71 in order to transfer the same into the inspection chamber 13 of the apparatus 11. It is clear that such mode requires intervention by an operator, who manually carries out said picking and transfer of the sample C_{X} to be tested, performing a movement substantially corresponding to the one shown schematically with arrow F₂.

A second mode is illustrated schematically in FIG. 4C and provides for automated picking, for example by means of a collaborative robot, or COBOT, 75, known per se, which is programmed to effect substantially the operation of picking the sample C_{X} from the tank 73 of the shuttle 71 and positioning said sample C_{X} into the seat 25 provided in the inspection chamber 13 of the apparatus 11.

It is understood that all manual operations performed by an operator may advantageously be performed by means of a collaborative robot, or other automated picking and releasing means.

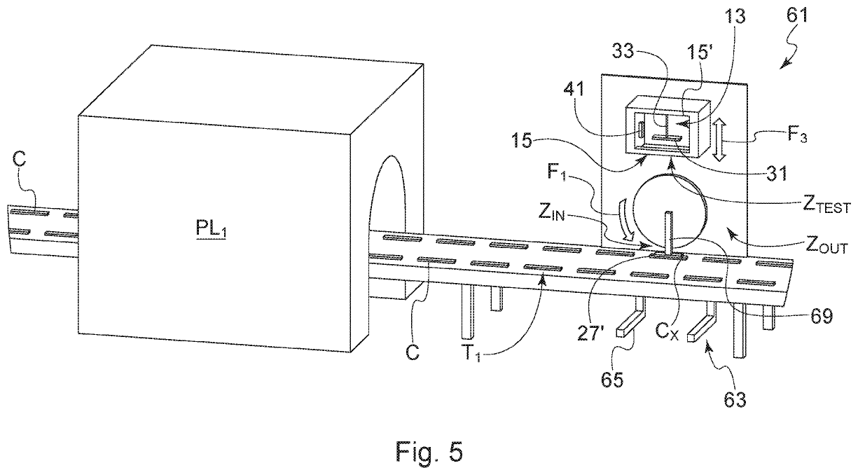

Referring now to FIG. 5, there is illustrated a first variant of the embodiment of the invention previously described with reference to FIGS. 4A-4C, wherein the apparatus 11 is associated with the support frame 63 of the pick-up mechanism 61, and, in addition, the inspection chamber 13 is slidable vertically along the vertical portion 67 of the frame 63, as indicated by arrow F₃, for moving to its distal or proximal configuration with respect to the belt T₁.

Advantageously, according to this embodiment, the opening 15 for the passage of the sample C_{X} is arranged below in the inspection chamber 13, i.e. on the base face of the parallelepiped body of the apparatus 11.

Frontally, as in the illustrated example, the apparatus 11 may comprise a further inspection opening 15′, for example closed by a door or provided with a transparent fixed surface.

According to this embodiment of the invention, the pick-up mechanism 61 with reciprocating motion is capable of periodically picking a package sample C_{X} from a first position Z_{IN} on a transport line coming from a plant PL₁, schematically shown in the figure, and comprising a conveyor belt T₁ on which a plurality of said packages C travel, and bringing said sample C_{X} to a test position Z_{TEST} with respect to said transport line T₁.

Said second position Z_{TEST} substantially corresponds to the opening 15, provided below in the inspection chamber 13, for the passage of the sample, when said inspection chamber 13 is in its proximal configuration with respect to the belt T₁.

According to this embodiment of the invention, the gripping means of the pick-up mechanism 61 are configured so as to hermetically close said opening 15 of the inspection chamber 13 and therefore preferably comprise a plate or tray 27′. Said gripping means may advantageously consist, for example, of one or more contact suckers, or Bernoulli suckers, or mechanical gripping hands.

Still referring to this first embodiment variant, actuation of the crank handle 69 can be controlled by the same electronic unit 43 with which the apparatus 11 is equipped. In addition, the crank handle 69 can be controlled to perform picking of the sample at the angle 0° corresponding to the position Z_{IN}, positioning of the picking means bringing the sample C_{X} to the angle 180° corresponding to the position Z_{TEST}, and releasing of the sample C_{X} at an angle between 180° and 270°, for example onto an inclined plane intended for depositing the tested samples into a suitable collection vessel and substantially corresponding to a position Z_{OUT}.

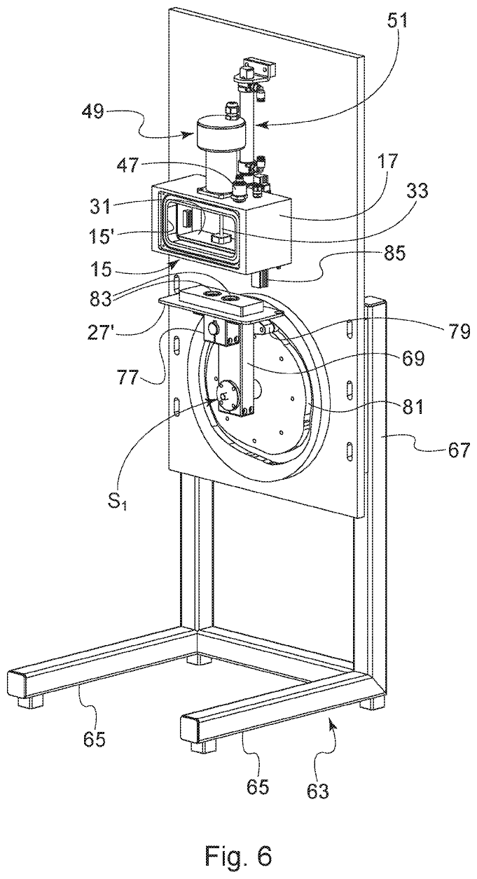

Referring to FIG. 6, there is illustrated a second variant of the embodiment of the invention previously described with reference to FIGS. 4A-4C, in which the apparatus 11 is associated with the support frame 63 of the pick-up mechanism 61, and, in addition, the pick-up mechanism 61 is provided with a guide cam for guiding the oscillating movement of the plate or tray 27′.

In this embodiment, the plate 27′ associated with the crank handle 69 of the pick-up mechanism 61 is mounted to an oscillating holder 77 driven by a slider 79 equipped with rollers sliding on the outer surface of an annular cam guide 81. The profile of the outer surface of the annular cam guide 81 is capable of orienting, during rotation of the crank handle 69, the plate 27′, so as to make the outer perimeter of said plate match the inner perimeter of the opening 15 provided below in the inspection chamber 13 for the passage of the sample C_{X}. In this way, smooth progressive engagement of the corresponding edges of the small 31 and the opening 15 and consequent hermetic closing of the opening 15 as well as smooth gripping of the product C_{X} from the belt T₁ without rubbing or jamming are advantageously achieved.

Still referring to this second embodiment variant, actuation of the crank handle 69 can be controlled by the same electronic unit 43 with which the apparatus 11 is equipped. In addition, the crank handle 69 can be controlled to perform picking of the sample at the angle 0° corresponding to the position Z_{IN}, positioning of the picking means at the angle 180° corresponding to the position Z_{TEST}, and releasing of the sample C_{X} at an angle between 180° and 270°, for example on an inclined plane intended for depositing the tested samples into a suitable collection vessel and substantially corresponding to a position Z_{OUT}.

Still referring to FIG. 6, picking means can be seen provided on the plate 27′ and comprising, in this embodiment, a pair of contact suckers 83 associated with a vacuum circuit passing trough the crank handle 69 and the plate 27′. Advantageously, the suckers 83 will also preferably be retractable into the plate 27′, in order to prevent the tested package sample from being in contact with deformable parts upon variation of the pressure inside the inspection chamber 13. It is indeed evident that the product package to be tested has to be in contact with rigid, non-deformable surfaces when the inspection chamber 13 is put under vacuum, and this in order to prevent alteration of the effect of the pressure variation on the package undergoing inspection.

A vertical guide 85 may be provided, in order to vertically displace the inspection chamber 13 relative to the frame 63, for example for adapting the vertical position of the opening 15 provided on the lower face of the inspection chamber 13 to the type of plate 27′ and corresponding package sample C_{X} to be tested.

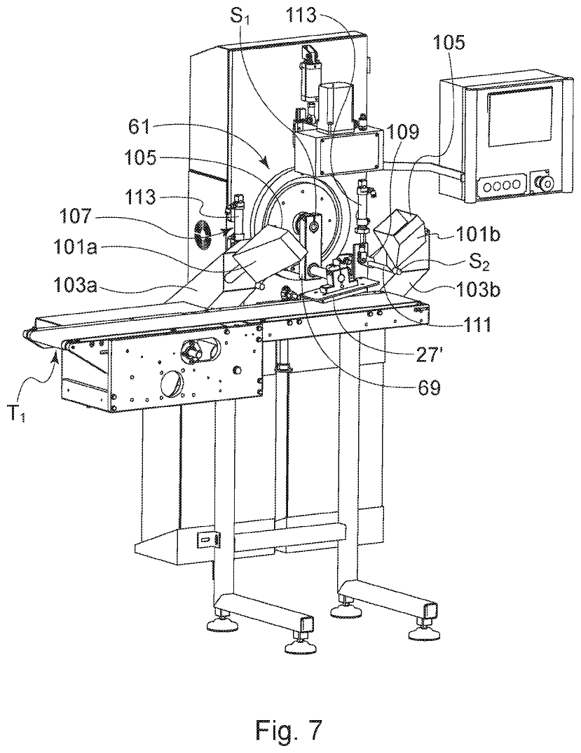

Referring now to FIG. 7, there is illustrated a particular embodiment of the variant previously described with reference to FIG. 5.

As along the transport line for the products there is no space for placing the products that have successfully passed the inspection stage, because all the available space is occupied by fresh products in transit, it is necessary to recover the products after inspection, in particular those products which have successfully passed the inspection and could therefore be reintroduced into the production cycle.

In comparison with the embodiment of FIG. 5, this particular embodiment shown in FIG. 7 comprises a pair of funnels 101a,101b and corresponding outlet channels 103a,103b, arranged laterally and on opposite sides with respect to the pick-up mechanism 61. More precisely, according to the illustrated embodiment, the mouth 105 of the funnels 101a,101b is arranged substantially in a plane tangent to a circumference concentric with the rotation axis S₁ of the crank handle 69. By suitably controlling the direction, clockwise or counterclockwise, of rotation of the crank handle 69 after inspection of the product and consequent release of the product by the plate 27′ into one of the funnels 101a,101b, it is advantageously possible to attain division of the products into two collection areas, depending on the favorable or unfavorable outcome of the inspection performed in the apparatus 11. In other words, compliant products, i.e. products that have successfully passed the inspection, will be released for example into the funnel 101a, and non-compliant products, i.e. products that have failed the inspection in the apparatus 11, will be released into the funnel 101b, or vice versa.

Advantageously, according to this particular embodiment of the invention, the apparatus, besides being capable of performing inspection of the product, further incorporates the possibility of discharging the product after inspection, depending on the outcome of the inspection, into two separate tanks (not shown) arranged at the outlet of the outlet channels 103a,103b, without requiring the presence of an operator.

Preferably, according to this embodiment of the invention, in order to facilitate discharging of the product into the corresponding funnel 101a,101b, each funnel is further associated with a corresponding tilting mechanism 107, in order to allow oscillation of the plane of the mouth 105 of the respective funnel about an oscillation axis S₂, substantially parallel to the rotation axis S₁ of the crank handle 69. Each tilting mechanism 107 comprises a lever arm 109 radially attached to a rotation shaft 111 with which a corresponding funnel 101a,101b is associated, and a pneumatic actuator 113, which, in the illustrated embodiment, is arranged along an axis substantially tangent to a circumference centered in the rotation axis S₁. In addition, the two actuator 113 are preferably parallel to each other and the rotation axes S₂ of the funnels 101a,101b are preferably arranged at about 120° along a circumference concentric with the rotation axis S₁. It is further to be noted that in this embodiment, it is indifferent in which direction the products travel on the belt T₁, said belt being movable from left to right in the figure, or vice versa, and the pick-up mechanism 61 being correspondingly controllable to rotate clockwise or counterclockwise.

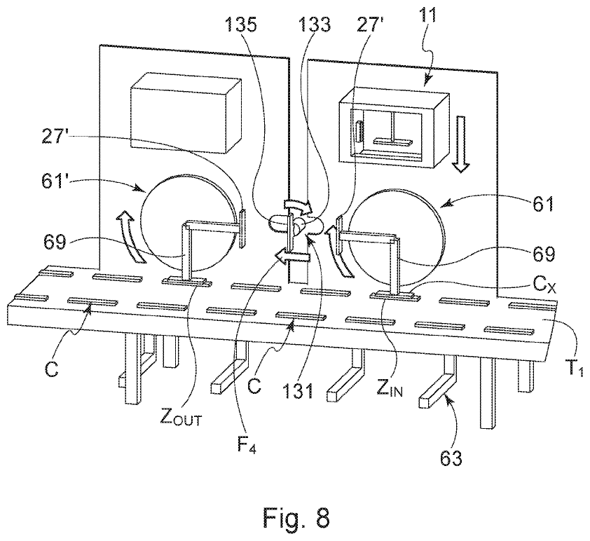

Although this embodiment has been described with reference to a pair of funnels 101a,101b and corresponding outlet channels, it is however possible to provide a single funnel and corresponding outlet channel for collecting for example only the discarded products, as will become evident from the following description with reference to the embodiment illustrated in FIG. 8.

Referring to FIG. 8, there is illustrated an embodiment of the apparatus 11, further comprising a pair of pick-up mechanisms 61,61′ capable of periodically picking a package sample C_{X} from a first position Z_{IN} on a conveyor belt T₁ on which a plurality of said packages C travel, and of releasing said sample C_{X} to a second position Z_{OUT} on said transport line T₁.

The structure of the pick-up mechanisms 61,61′ is substantially the same as the one described with reference to FIG. 5. The pick-up mechanism 61 arranged on the right in FIG. 8 performs picking of a sample C_{X} from the belt T₁ when said sample is in the position Z_{IN} on said belt, i.e. when the sample C_{X} is essentially tangent to a circumference centered in the rotation axis S₁. Said sample C_{X} picked by the mechanism 61 is sent to the inspection stage in the apparatus 11 arranged above in the frame 63, according to the mode previously described especially in connection with the embodiment illustrated in FIG. 5. During this step of transferring the product C_{X} from the belt T₁ to the apparatus 11, the crank handle 69 can be controlled to rotate clockwise or counterclockwise, depending on the advancement direction of the belt T₁.

After the inspection stage, performed at the apparatus 11, the pick-up mechanism 61 is actuated again to bring the sample C_{X} to a position of transfer of the sample C_{X} to the pick-up mechanism 61′ arranged adjacent thereto. The sample C_{X}, once picked by the mechanism 61′, can advantageously be released onto the belt T₁ downstream of the position Z_{IN} from which the sample C_{X} has been picked. The pick-up mechanism 61′ therefore substantially operates as a pick-up mechanism, picking a sample from the pick-up mechanism 61 and releasing it onto the belt T₁.

It has to be noted that, as the products are arranged regularly on the belt, and usually there is provided no free space for placing a new products, and in addition the space created on the belt T₁ by picking the tested sample has already passed through the position Z_{OUT}, the speed of the belt being much higher than the time required to perform the set of steps and the inspection test, the sample C_{X} will be held by the plate 27′ of the mechanism 61′ until the pick-up mechanism 61 picks a following sample in order to perform another inspection cycle.

The transfer of the product C_{X} from the mechanism 61 to the mechanism 61′ preferably takes place by means of an intermediate tilting mechanism 131, the purpose of which is to make sure that, at the end of the pick and release cycle carried out by the mechanisms 61 and 61′, respectively, the sample C_{X} is positioned on the belt T₁ oriented with the same face upwards as when said sample C_{X} was picked.

In this embodiment, the tilting mechanism 131 comprises a rotatable shaft 133 with which an intermediate plate 135 is associated, provided with retaining means, for example of the pneumatic type, for retaining the product sample to be transferred from the mechanism 61 to the mechanism 61′.

According to the invention, radial approaching of the plate 27′ of the mechanism 61 to the intermediate plate 135 for releasing the sample C_{X} onto said intermediate plate and subsequent moving away thereof can be obtained according to some different modes.

A first preferred mode, applicable in those cases in which the tilting mechanism 131 is present, provides that the shaft 133 be supported by a movable structure (not shown), capable of moving said shaft 133 parallel to itself along a direction indicated by arrow F₄ in the figure and substantially parallel to the plane of the conveyor belt T₁.

A second mode, applicable also in the absence of the mechanism 131, provides that the arm of the crank handle 69 of the two mechanisms 61 and 61′ be extendable and be therefore able to move from a proximal position, in which the plate 27′ is close to the axis S₁, to a distal position in which the plate 27′ is distal to said axis S₁ and proximal to the intermediate plate 135 associated with the rotatable shaft 133. Extension and retraction of the plate 27′ can be obtained, for example, by means of an actuator incorporated in a telescopic arm of the crank handle 69.

A third mode, applicable also in the absence of the mechanism 131, provides that the mechanisms 61 and 61′, or the corresponding frames carrying said mechanisms, be provided with a translational movement in order to bring them to a proximal or distal configuration relative to the intermediate tilting mechanism 131 along a direction parallel to the arrow F₄.

Of course, all the movements will be controlled by a computer program loaded in a memory associated with an electronic control unit.

In a particular embodiment, the mechanism 61′ can be associated with an apparatus 11′, identical and redundant with respect to the apparatus 11, for example to make up for malfunctions of the latter, or different and capable of performing inspections of a different kind, such as optical inspections such as reading of codes or defects, dimensional inspections, or inspections with gamma rays, X rays, or infrared, for other checking purposes or other demands of the industrial process of product preparation.

The inspection method according to the invention will now be described in a preferred embodiment thereof.

The method was developed through tests carried out on several types of samples, and at that stage it was possible to identify features common to all the examined products. The testing stage had the purpose of obtaining correlations that could be analysed automatically by the inspection apparatus, so as to define a flow chart of the operations to be executed by an algorithm implemented in the software controlling the functions of the apparatus.

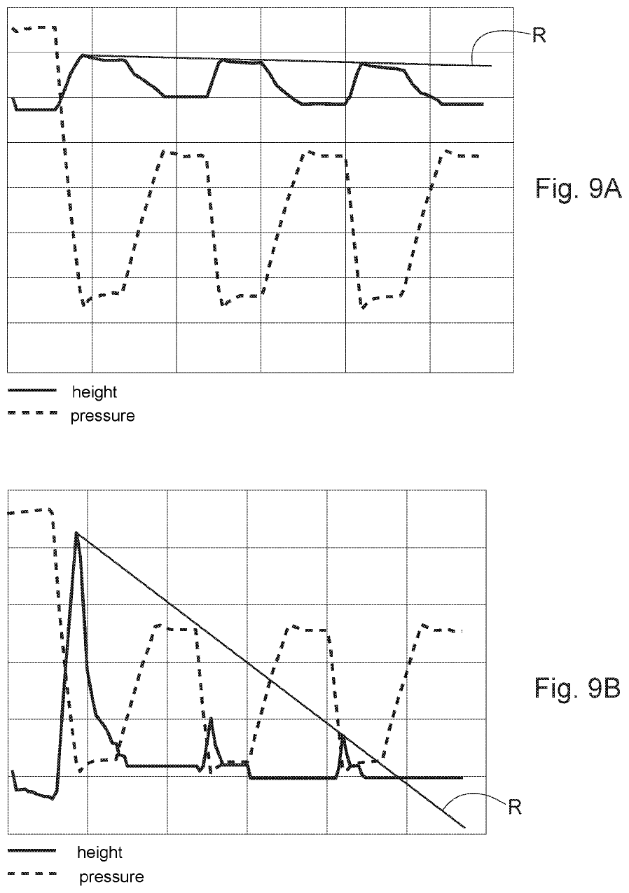

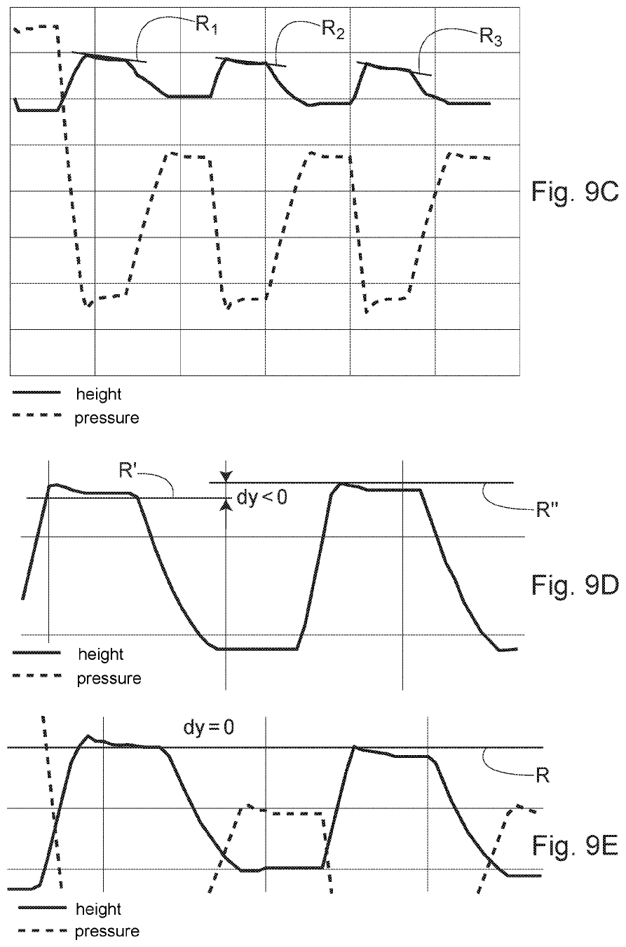

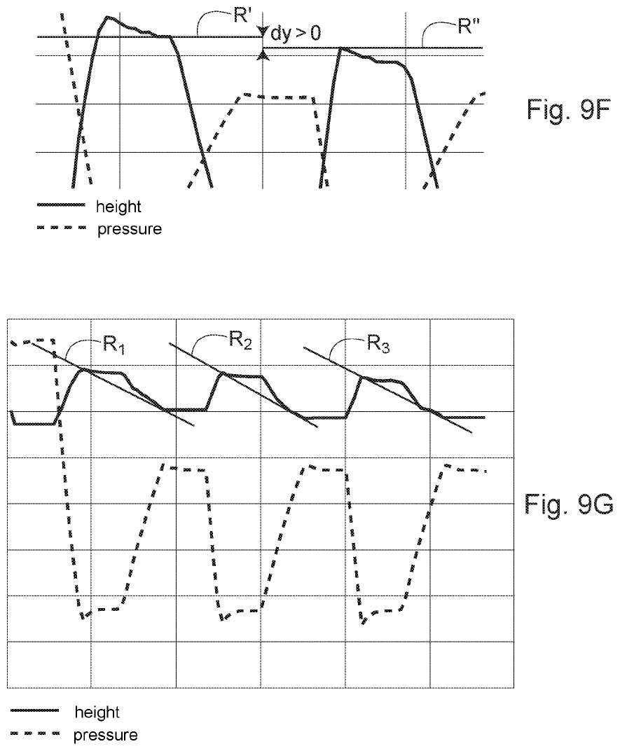

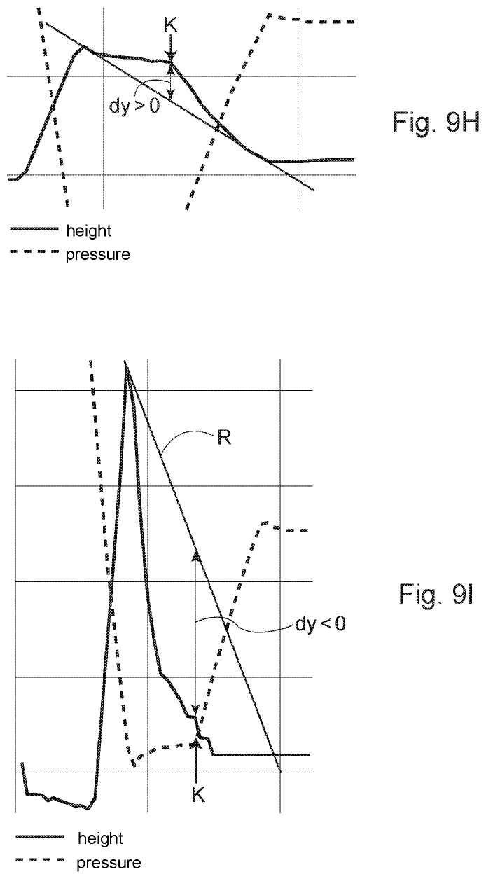

Referring now to FIG. 9A, there are illustrated curves of pressure and height, or thickness, of the package undergoing inspection. The package is subjected to a succession of inspection cycles, and by joining the peaks of the curve indicative of the variation in height of the package, upon variation of the pressure, a straight line R is defined, the angular coefficient of which is indicative of the presence of a gas leakage from the package and, consequently, of a defective package.

In particular, a straight line R entirely horizontal, i.e. having an angular coefficient of zero, or approximately zero, is indicative of a substantially negligible gas leakage, whereas an angular coefficient exceeding a predetermined threshold is indicative of a non-negligible leakage and thus of the need to discard the product sample.

It is advantageous to establish, for each type of product, a threshold of said angular coefficient, by using a “master” package in a step of threshold characterization, before implementing the method in normal industrial production.

The case in which, as shown in FIG. 9B, not all the peaks intersect the straight line R, is also a condition indicative of the fact that the package being examined does not comply with the manufacturer's specifications.

In FIG. 9C there are further considered the trend lines of the points of the plateaus of the straight lines R₁, R₂, R₃, whose equations are obtained by means of linear regressions of the points forming the plateau of measurements at constant pressure (lower pressure threshold). The presence of this plateau implies that the package offers some resistance to the escape of gas. A horizontal line therefore means negligible leaks, whereas a vertical line will be present in case of sudden failure of the package and will therefore be indicative of the need to discard the package and the product contained therein.

Another parameter for plateau points providing useful information about the escape of gases from the package, is the height difference dy between the straight lines R′ and R″ passing through the last point of a plateau and the first point of the following plateau, as illustrated in FIGS. 9D to 9F. Such difference dy can be lower than or equal to zero and correspondingly indicative of an optimal or satisfactory package, or higher than zero and indicative of a package to be discarded. In FIG. 9G there are shown the straight lines R1, R2, R3 obtained by making the straight line pass between the first point of the plateau generated by the measurements at constant pressure of the lower threshold and the first point of the plateau generated by the measurements at constant pressure of the higher pressure.

A study of these straight lines can provide several information: by defining as “knee” K the last point of the plateaus generated by the measurements at constant pressure, FIGS. 9H e 9I, it is possible to assess the height difference between that point and the straight line defined before. If the difference is lower than or equal to zero, the package is certainly to be identified as “non-compliant”. In other words, if the “knee” K is below the straight line passing through the maximum and minimum points, the test will give a negative result and the package will therefore have to be discarded, whereas, if the “knee” K is above the aforementioned straight line joining the maximum and minimum points, the package can be considered as optimal or satisfactory.

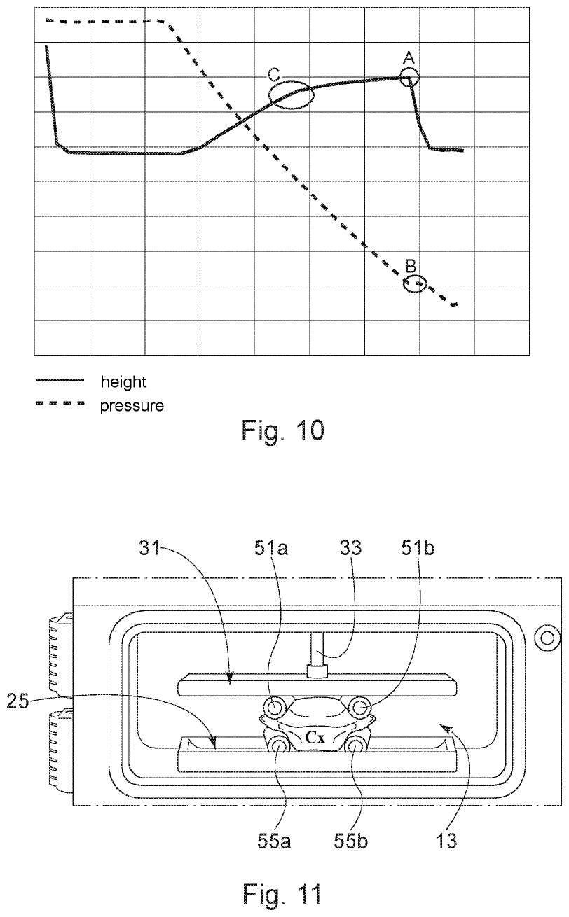

Referring to FIG. 10, there is illustrated the diagram of pressure and height or thickness variation of a package sample subjected to a destructive inspection in the apparatus according to the invention.

The destructive inspection of packages is usually carried out in order to determine the maximum vacuum that the package can tolerate before undergoing failure. As is known, the maximum vacuum threshold may vary according to the environment in which the package is intended to be used. Packages intended, for example, for being transported by air will have to withstand greater vacuums than packages intended for the local market, which are transported by land.

During the destructive inspection, the hermetic inspection chamber of the apparatus is subjected to an increasing vacuum (curve indicated by a broken line in the figure) and in the meantime deformations of the package, i.e. thickness or height variations (curve indicated by a continuous line in the figure) are detected.

The curve indicative of the thickness of the package undergoes an inflection, indicated by the letter “C” in the figure, at the time the elastic forces of the material of which the package is made start counteracting further expansions due to the increasing vacuum inside the inspection chamber.

The yielding of the material of the package can be seen both on the curve indicative of the thickness variation of the package, with a steep slope down in the area indicated by the letter “A” in the figure, and on the curve indicative of the pressure variation, with the “hump” in the area indicated by the letter “B” in the figure.

In the case where the apparatus is provided with a mechanical transducer 23, like the one described with reference to FIG. 1, the steep slope down started in the area “A” stops when the small plate 31 comes into contact with the product contained in the package.

The “hump” of the pressure curve in the area “B” is due to the fact that the gas contained in the package is liberated into the inspection chamber 13 at the time of yielding, thus momentarily raising the pressure.

A particular embodiment of the method for inspecting flexible packages according to the invention provides for comparing the correlation between the curve indicative of the variation of a geometric parameter of the package sample and the curve indicative of the pressure variation, with a predetermined correlation threshold.

The correlation between said curves can be obtained for example by the formula:

$$r = \frac{{\sum }_{i = 0}^{N} ( {x}_{i} - \overline{x} ) ( {y}_{i} - \overline{y} )}{\sqrt{{\sum }_{i = 0}^{N} {( {x}_{i} - \overline{x} )}^{2} {\sum }_{i = 0}^{N} {( {y}_{i} - \overline{y} )}^{2}}}$$

$$where : \overline{x} = \frac{{\sum }_{i = 0}^{N} {x}_{i}}{N}$$

$$\overline{y} = \frac{{\sum }_{i = 0}^{N} {y}_{i}}{N}$$

High correlation values will be indicative of the fact that the package meets the requirements, whereas low values will be indicative of defective packages that are therefore to be discarded.

According to the invention, the parameters illustrated with reference to FIGS. 9A-9I and 10 can be used, either in combination or individually, in an algorithm for calculating the condition of discard or approval of the package, whereby there can exist inspection apparatuses in which all, or some, or even only one of said parameters are used.

With reference to FIG. 11, advantageously, according to the invention, the seat 25 for receiving the package to be tested and the small plate 31 of the measuring unit for measuring at least one geometric parameter of the package sample to be tested have a shape selected according to the shape and rigidity of the package to be tested.

In the illustrated embodiment, the seat 25 and the small plate 31 comprise corresponding flat plates each having a pair of parallel cylindrical projections. The cylindrical projections 53a,53b of the small plate 31 and the cylindrical projections 55a,55b of the seat 25 are substantially aligned and press against the opposite edges of the package sample C_{X} to be tested, when the small plate 31 is in its lowered configuration as illustrated in the figure.

The invention as described and illustrated is susceptible to several variations and modifications falling within the same inventive principle.

1. Apparatus (11) for inspecting flexible packages, comprising:
an inspection chamber (13) having a closeable opening (15) for the passage of a sample to be examined and associatable with means capable of generating a decrease in the pressure inside the inspection chamber (13);
a programmable electronic processing unit (43);
a measuring unit, controlled by the programmable unit (43), for measuring at least one geometric parameter of a sample (C_{X}) received in the inspection chamber (13);
a pressure sensor unit, comprising at least one pressure sensor (47), associated with the programmable unit and capable of measuring the pressure inside the inspection chamber (13);
wherein the electronic unit (43) is programmed to make the apparatus (11) perform the steps of:
i. determining at least one geometric parameter of the sample (C_{X}) by means of said measuring unit when a starting pressure P₁ is established in the inspection chamber (13);
ii. causing, by means of said pressure-decreasing means, a decrease in the pressure inside the inspection chamber (13) until a predetermined pressure value P₂<P₁ is reached by means of a vacuum pumping unit;
iii. causing an increase in the pressure inside the inspection chamber (13) until the starting pressure value P₁ is reached again;
iv. possibly repeating the steps ii) and iii) with the same or different pressure values;
v. determining, by means of said measuring unit, the variation, if any, of said at least one geometric parameter of the sample (C_{X}) as a result of said pressure variations;
vi. generating a signal indicative of said variation, if any.

2. The apparatus according to claim 1, wherein said electronic unit (43) is programmed to make the apparatus (11) perform an inspection cycle comprising a sequence of pressure variations inside the inspection chamber and of measurements of the corresponding variation of at least one geometric parameter of the sample (C_{X}), the measurements obtained being compared with reference values in order to generate a signal indicative of the presence or absence of a defect in the package.

3. The apparatus according to claim 1, wherein the measuring unit comprises a seat (25) provided in said inspection chamber (13) and adapted to house a package sample (C_{X}), said seat being preferably defined in an interchangeable tray (27).

4. The apparatus according to claim 3, wherein the measuring unit further comprises a linear position transducer having a probe movable relative to said seat (25) and capable of taking a distal configuration and a proximal configuration with respect to said seat (25).

5. The apparatus according to claim 4, wherein the transducer is provided with a small plate (31) extending in a plane substantially parallel to the base (25a) of the seat (25) intended to receive and support the sample (C_{X}).

6. The apparatus according to claim 5, wherein the small plate (31) has a surface having a geometric shape complementary to that of the seat for the package to be tested, and an extension substantially comparable to that of the seat (25).

7. The apparatus according to claim 4, wherein the measuring unit comprises at least one optical sensor (41) capable of generating a signal indicative of at least one geometric parameter of the package sample (C_{X}).

8. The apparatus according to claim 1, wherein there is provided a pick-up mechanism (61) with reciprocating motion, capable of periodically picking a package sample (C_{X}) from a first position (Z_{IN}) on a transport line on which a plurality of packages travel, and of releasing said sample (C_{X}) to a second position (Z_{OUT}) with respect to said transport line.

9. The apparatus according to claim 8, wherein a carriage or automated shuttle (71) is provided for transferring the sample (C_{X}) from said second position (Z_{OUT}) to a position (Z_{TEST}) proximal to said inspection chamber (13), and possibly a collaborative robot (75) capable of picking the sample (C_{X}) from said carriage or shuttle (71) for transferring it into said inspection chamber (13).

10. The apparatus according to claim 9, wherein said opening (15) is closeable by a plate (27′) associated with said pick-up mechanism (61), and wherein said seat (25) is defined in said plate (27′).

11. The apparatus according to claim 1, further comprising a pair of pick-up mechanisms (61,61′) capable of periodically picking a package sample (C_{X}) from a first position (Z_{IN}) on a conveyor belt (T₁) on which a plurality of said packages travel and of releasing said sample (C_{X}) to a second position (Z_{OUT}) on said transport line (T₁), wherein the transfer of the sample (C_{X}) from a first mechanism (61) to a second mechanism (61′) takes place by means of an intermediate tilting mechanism (131), the purpose of which is to make sure that, at the end of the pick-up and release cycle carried out by the respective mechanisms (61,61′), the sample (C_{X}) is positioned on the belt (T₁) with the same face oriented upwards as when said sample (C_{X}) was picked.

12. The apparatus according to claim 1, wherein the measuring unit for measuring at least one geometric parameter of a sample (C_{X}) received in the inspection chamber (13) and the pressure sensor unit are in communication with said chamber, whereby the pressure inside the instrumentation is equal to the pressure within the inspection chamber, thus preventing pressure differences from altering the accuracy of measurement.

13. Method for inspecting flexible packages, comprising the steps of:
providing an inspection chamber (13) having a closeable opening (15) for the passage of a sample (C_{X}) to be examined and associatable with means capable of creating a decrease in the pressure inside the inspection chamber;
providing a programmable electronic processing unit (43);
providing a measuring unit, controlled by the programmable unit (43), for measuring at least one geometric parameter of a sample (C_{X}) received in the inspection chamber (13);
providing a pressure sensor unit, comprising at least one pressure sensor (47), associated with the programmable unit and capable of measuring the pressure inside the inspection chamber (13);
wherein said method comprises the steps of:
i. determining at least one geometric parameter of the sample (C_{X}) by means of said measuring unit when a starting pressure P₁ is established in the inspection chamber (13);
ii. causing, by means of said pressure-decreasing means, a decrease in the pressure inside the inspection chamber (13) until a predetermined pressure value P₂<P₁ is reached;
iii. causing an increase in the pressure inside the inspection chamber (13) until the starting pressure value P₁ is reached again;
iv. possibly repeating the steps ii) and iii) with the same or different pressure values;
v. determining, by means of said measuring unit, the variation, if any, of said at least one geometric parameter of the sample (C_{X}) as a result of said pressure variations;
vi. generating a signal indicative of said variation.

14. The method according to claim 13, wherein the sample (C_{X}) is subjected to a sequence of inspection cycles, and wherein there is provided a step of comparing the curves indicative of the variation of a geometric parameter of the package sample, upon variation of the pressure.

15. The method according to claim 14, wherein said comparison takes place in conjunction with or as an alternative to one of the following steps:
the angular coefficient of the straight line (R) connecting the peaks of the curve indicative of the height variation of the package, with a predetermined threshold;
the number of said peaks and the number of times in which a same straight line (R) intersects said peaks;
the angular coefficient of the straight line (R₁, R₂, R₃) whose equation corresponds to the linear regression of the points forming the plateaus of said curve, with a predetermined threshold;
the distance dy of ordinates between the straight lines (R′) and (R″) passing through the last point of a plateau and the first point of the subsequent plateau, with zero;
the distance dy of ordinates between the straight lines (R₁, R₂, R₃) passing through the first point of the plateau generated by the measurements under constant pressure at lower pressure threshold and the first point of the plateau generated by the measurements under constant pressure at higher pressure, with zero;
the distance of ordinates between the last point or “knee” of the plateaus generated by the measurements under constant pressure with lower pressure and the straight line formerly defined, with zero;
the correlation between the curve indicative of the variation of a geometric parameter of the package sample and the curve indicative of the pressure variation inside the inspection chamber, with a predetermined correlation threshold.

16. The method according to claim 13, wherein a step of mechanically causing squashing of the sample is provided, so as to liberate, inside the package, the gas contained in the product.

17. The method according to claim 16, wherein the step of mechanical squashing is obtained by means of an instrument comprising an appendix connected to a pneumatic cylinder or equivalent thereto, capable of imparting an impulsive thrust in order to cause the aforesaid effect of squashing the product inside the package.

18. The method according to claim 13, wherein a step of picking, by means of an automated pick-up mechanism, the package sample to be tested from a transport line for packaged products, and a step of positioning the picked sample into the chamber of the inspection apparatus are provided.

19. The method according to claim 17, wherein said picking step is obtained by means of gripping suckers capable of retaining the product package also during testing in the inspection chamber and are retractable into a support plate supporting the product package to be inspected, in order to prevent the tested product sample from being in contact with deformable parts upon variation of the pressure.

20. The method according to claim 13, wherein a step is provided in which an appendix (31) is brought into contact with the wall of the package sample (C_{X}) and preferably subsequently pressed in order to stretch the wall of the package sample (C_{X}), preferably however without deforming the product contained therein, so that the pressure difference between the inside of the package sample (C_{X}) and the volume of the inspection chamber (13) is increased.
